(19) United States
(12) Patent Application Publication
(10) Pub. No.: US 2010/0072836 A1
(43) Pub. Date: Mar. 25, 2010

(54) Cooling Device for Feeding Motor of Pick-Up Head

(75) Inventors: Yao-Ching Tsai, Guishan Shiang (TW); Jen-Chen Wu, Guishan Shiang (TW)

Correspondence Address: NIKOLAI & MERSEREAU, P.A., 900 SECOND AVENUE SOUTH, SUITE 820, MINNEAPOLIS, MN, 55402, US

(73) Assignee: QUANTA STORAGE INC., Guishan Shiang, Taoyuan County 333 (TW)

(21) Appl. No.: 12/481,875

(22) Filed: Jun. 10, 2009

(30) Foreign Application Priority Data
Sep. 23, 2008 (TW) 097136589

(51) Int. Cl. H02K 9/02

(52) U.S. Cl. 310/58

(57) ABSTRACT

The invention provides a cooling device for the feeding motor of a pick-up head on a traverse covered a protection plate. The protection plate disposes a long slot along the major axis of the traverse. One end of the long slot disposes a spindle rotating a disc above the protection plate. A feeding motor rotates a screw bar to move the pick-up head back and forward along the long slot. A diffuser is connected to at least one side of the upper surface of the feeding motor. An install recess on the protection plate faces the rotating disc and accommodates the upper surface and the diffuser to increase the cooling effect.

### FIELD OF THE INVENTION

The present invention relates to a feeding motor of the optical disk device, and in particular to a cooling device decreasing the temperature heated by the rotation of a feeding motor driving a pick-up head.

### BACKGROUND OF THE INVENTION

With demands of the high-solution video, the capacity of optical disc has rapidly raised. The optical disk device needs to move the pick-up head in higher speed in short time along the radial direction of the optical disc rotating in high speed in order to search and read,write the data needed on the optical disc.

FIG. 1 shows a traverse (1) of a conventional optical disk device. A spindle (2) disposed on the traverse (1) rotating an optical disc (3) in high speed. The traverse (1) is covered by a protecting plate (4) disposing a long slot (5) along the radial direction of the spindle (2) and the major axis of the traverse (1). A feeding motor (6) is disposed on one side of the spindle (2) to rotate a screw bar moving a pickup head (7) back and forth along a long slot (5). The pick-up head (7) projects and focuses a laser beam on the optical disc (3) to read the data mark on the optical disc (3) according to the signal strength of the catoptric light reflected by the optical disc (3).

Although an install recess (8) disposed on the protection plate (4) near the side of the spindle (2) of the traverse (1) accommodates a part of the feeding motor (6) and makes the surface of the feeding motor (6) flush with the protection (4) to decrease the tier of the feeding motor and the protection plate and to lessen the thickness of the optical disk device after installing the feeding motor (6) on the traverse (1), the surface of the install recess (8) reveals the feeding motor (6) exposed to airflows caused by the optical disc (3) rotating in high speed, the airflows well diffusing the heat generated easily by the feeding motor (6) rotating in high speed.

However, the exposed part of the feeding motor (6) could not diffuse the heat completely, and the rotating temperature of the feeding motor (6) still increases to influence the temperature inside the optical disk device. Components sensitive to heat such as the laser diode of the pick-up head or the phase-change disc (PD) are getting hard to control. Hence there are still problems to be solved about the heat diffusion for the feeding motor of a pick-up head of the conventional optical disk device.

### SUMMARY OF THE INVENTION

An objective of the present invention is to provide a cooling device for a feeding motor of a pick-up head, which disposes a diffuser extending from the feeding motor to increase the area of the feeding motor exposed to airflows caused by an optical disc rotating in high speed, and to completely diffuse heat.

Another objective of the present invention is to provide a cooling device for a feeding motor of a pick-up head, which uses a feeding motor directly contacting a protection plate, a metal protection plate as a diffuser of the feeding motor, to completely diffuse heat.

In order to achieve the foregoing objectives of the invention, a cooling device for a feeding motor of a pick-up head according to the present invention is disposed on a traverse covered by a protection plate disposing a long slot, one end of the long slot disposing a spindle rotating an optical disc above the protection plate, the traverse disposing a feeding motor to rotate a screw bar moving the pick-up head back and forth along the long slot, an install recess is disposed on the protection plate and faces the rotating optical disc, and a diffuser connects to at least one side of an upper surface of the feeding motor and is accommodated with the upper surface of the feeding motor by the install recess.

A further embodiment of the present invention provides a cooling device for a feeding motor of a pick-up head, in which the cooling device is disposed on a traverse covered by a metal protection plate disposing a long slot along the major axis of the traverse, one end of the long slot disposing a spindle rotating an optical disc above the protection plate, the traverse disposing a feeding motor to rotate a screw bar moving the pick-up head back and forth along the long slot, aid an install recess is disposed on the protection plate and faces the rotating optical disc and accommodates the upper surface of the feeding motor, at least one side of the upper surface of the feeding motor connected to the protection gate.

### BRIEF DESCRIPTION OF THE DRAWINGS

FIG. 1 is a pictorial drawing showing the conventional traverse;

FIG. 2 is an exploded view showing the cooling device for the feeding motor of the pick-up head on the traverse according to the first embodiment of the invention;

FIG. 3 is a pictorial drawing showing the cooling device for the feeding motor of the pick-up head on the traverse according to the first embodiment of the invention;

FIG. 4 is a diagram showing the operation of the cooling device for the feeding motor of the pick-up head on the traverse according to the first embodiment of the invention; and

FIG. 5 is a partial pictorial drawing showing the cooling device for the feeding motor of the pick-up head on the traverse according to the second embodiment of the invention.

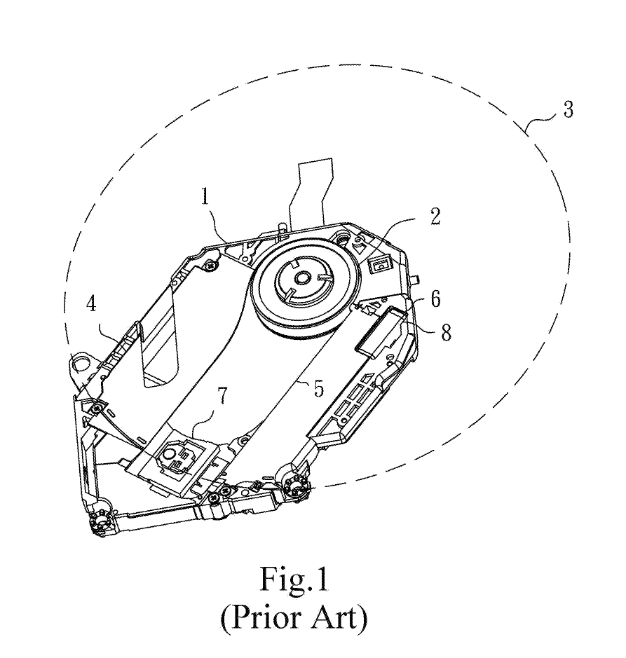

### DETAILED DESCRIPTION OF THE INVENTION

The techniques employed by the present invention to achieve the foregoing objectives and the effects thereof are described hereinafter by way of examples with reference to the accompanying drawings.

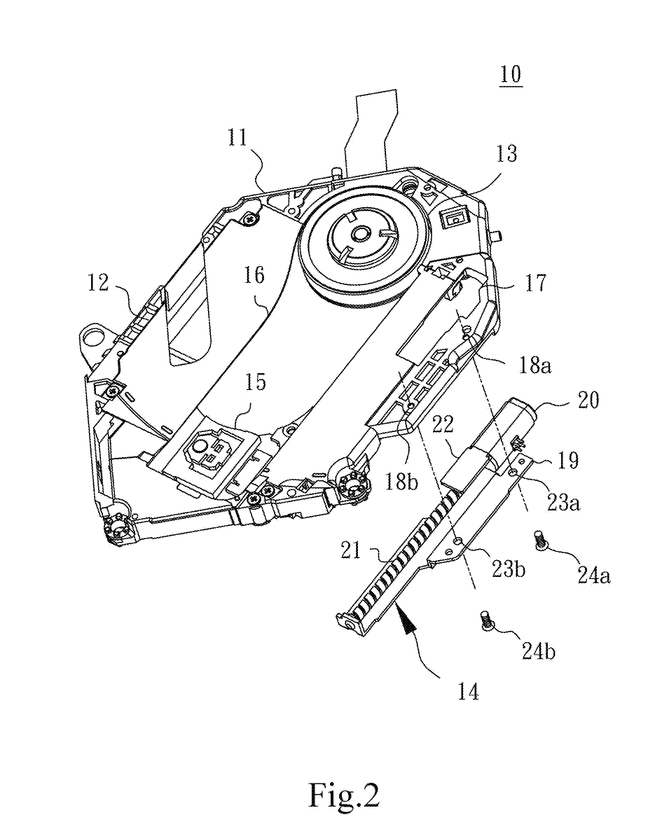

FIG. 2 is an exploded view showing the cooling device for the feeding motor of the pick-up head on the traverse according to the first embodiment of the invention. Referring to FIG. 2, the traverse (10) comprises a body (11), a protection plate (12), a spindle (13), a feeding device (14) and a pick-up head (15). Wherein, the body (11) of the traverse (10) is basically a polygonal plate, and the upper surface of the body (11) is covered by the protection plate (12) disposing a long slot (16) along the major axis of the body (11), one end of the long slot (16) disposing the spindle (13) rotating an optical disc above the protection plate (12).

An install recess is dug on the protection plate (12) near the side of the spindle (13) and directly faces the rotating optical disc, and two resembling holes (18a and 18b) are disposed on the side near the install recess (17) of the body (11). The feeding device (14) includes a base plate (19), a feeding motor (20), a screw bar (21) and a diffuser (22). Two fix holes (23a and 23b) are disposed on the side relative to the position of the two resembling holes (18a and 18b) of the base plate (19). One end of the base plate (19) disposes the feeding motor (20), the other end supports one end of the screw bar (21), and the other end of the screw bar (21) driven by the feeding motor connects to the feeding motor (20).

The cooling device according to the first embodiment of the present invention uses a plate diffuser (22) connected to the upper surface of the feeding motor (20), approximately flushing with the upper surface of the feeding motor (20) and extending a appropriate distance to the aspect of the connection with the screw bar (21), but it should not be construed as a limitation on the actual applicable scope of the invention. The diffuser (22) could connect to at least one side of the feeding motor (20) and extend to all aspects that allow accommodating the diffuser (22), and the diffuser (22) could also be the extension of the upper surface of the feeding motor (20). The pick-up head is disposed on the long slot (16).

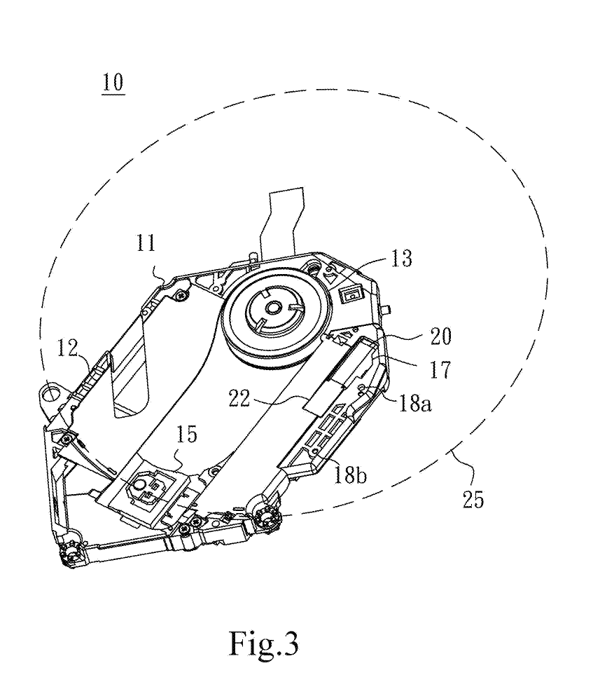

Referring to FIG. 2 and FIG. 3, FIG. 3 shows the assembled traverse (10). In assembling of the traverse (10), two screw bolts (24a and 24b) pass through the two fix holes (23a and 23b) and are screwed to the two assembling holes (18a and 18b) to fix the feeding device (14) on the body (11). After assembling the traverse (10), the upper surface of the feeding motor (20) and the diffuser (22), the extension of the upper surface of the feeding motor, are accommodated by the install recess (17) to approximately flush with the protection plate (12) and to avoid influencing an optical disc (25) rotated by the spindle (13). One end of the pick-up head (15) interlocks the screw bar (21) and is driven by the screw bar (21) to move back and forth along the long slot (16) in order to read/write the data on the optical disc (25).

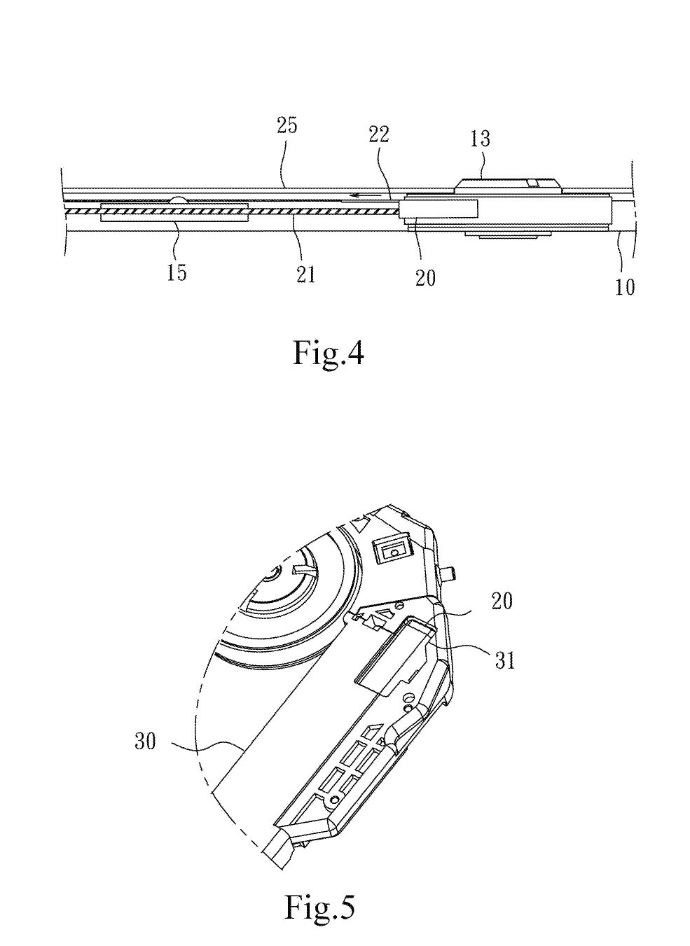

FIG. 4 is a diagram showing the operation of the cooling device for the feeding motor of the pick-up head on the traverse (10) according to the first embodiment of the invention. When the spindle (13) rotates the optical disc (25) in high speed, the feeding motor (20) rapidly rotates the screw bar (21) to move the pick-up head (15). The heat generated by the feeding motor (20) rotating in high speed is spread to all surfaces of the feeding motor (20). As a result of the upper surface of the feeding motor (20) and the diffuser (22) connecting to it, facing the rotating optical disc (25), the optical disc rotating in high speed drives the surrounding air to flow rapidly and become airflows (as the arrow shown by the FIG. 4). The upper surface of the feeding motor (20) and the diffuser (22) connecting to it provide a greater area for heat exchange and are directly exposed to the airflows to reach a better heat transfer efficiency, and the airflows rapidly take away the heat generated by the feeding motor (20) to increase the cooling effect for the feeding motor (20).

FIG. 5 is a partial pictorial drawing showing the cooling device for the feeding motor of the pick-up head on the traverse according to the second embodiment of the invention. The traverse with the cooling device for the feeding motor of the pick-up head according to the second embodiment has same basic structure as it of the traverse according to the first embodiment, so the same components of both embodiments are labeled in same number to simplify the description. The difference between two traverses of both said embodiments is a feeding motor (20) connected to a protection plate (30) directly in the second embodiment. An install recess (31) on the protection plate (30) only accommodates the upper surface of the feeding motor (20). The side near a screw bar of the upper surface of the feeding motor connects to the protection plate (30) in order to use the metal protection plate (30) as a diffuser of the feeding motor (20) to form the cooling device for the feeding motor of the pick-up head of the second embodiment, but it should not be construed as a limitation on the actual applicable scope of the invention. At least one side of the upper surface of the feeding motor (20) could connect to the protection plate (30) to form a diffuser. Due to the protection plate (30) close to the optical disc rotating in high speed, the heat transfer effect is the best. The heat generated by the feeding motor (20) is adequately diffused.

Hence the cooling device for the feeding motor of the pick-up head according to the present invention uses a diffuser, the extension from a feeding motor, to increase the area of the feeding motor exposing to airflows caused by an optical disc rotating in high speed and to raise the cooling effect: or uses a feeding motor directly connecting to a protection plate: a metal protection plate as a diffuser of the feeding motor, to adequately diffuse heat and to achieve the objective of reducing the operation temperature inside an optical disk device.

The preferred embodiments of the present invention have been disclosed in the examples. However the examples should not be construed as a limitation on the actual applicable scope of the inventions and as such, all modifications and alterations without departing from the spirits of the invention and appended claims shall remain within the protected scope and claims of the invention.

What is claimed is:

1. A cooling device for a feeding motor of a pick-up head the cooling device disposed on a traverse covered a protection plate disposing a long slot along the major axis of the traverse, one end of the long slot disposing a spindle rotating a disc above the protection plate, the traverse disposing a screw bar rotated by the feeding motor to move the pick-up head back and forward along the long slot, the cooling device comprising:
an install recess disposed on the protection plate and facing the rotating disc; and
a diffuser connecting to at least one side of an upper surface of the feeding motor and accommodated with the upper surface of the feeding motor by the install recess.

2. The cooling device for a feeding motor of a pick-up head according to claim 1, wherein the upper surface of the feeding motor is flush with the diffuser.

3. The cooling device for a feeding motor of a pick-up head according to claim 2, wherein the upper surface of the feeding motor and the diffuser are flush with the protection plate.

4. The cooling device for a feeding motor of a pick-up head according to claim 1, wherein the install recess is disposed on one side of the spindle.

5. The cooling device for a feeding motor of a pick-up head according to claim 1, wherein the diffuser is a one-piece extension of the upper surface of the feeding motor.

6. The cooling device for a feeding motor of a pick-up head according to claim 1, wherein the diffuser connects to one side of the upper surface of the feeding motor and extends to the aspect of the screw bar.

7. A cooling device for a feeding motor of a pick-up head, the cooling device disposed on a traverse covered a metal protection plate disposing a long slot along the major axis of the traverse, one end of the long slot disposing a spindle rotating a disc above the protection plate, the traverse disposing a screw bar rotated by the feeding motor to move the pick-up head back and forward along the long slot, the cooling device comprising:
an install recess disposed on the protection plate, facing the rotating disc and accommodating an upper surface of the feeding motor, at least one side of the upper surface of the feeding motor connected to the protection plate.

8. The cooling device for a feeding motor of a pick-up head according to claim 7, wherein a side near the screw bar of the upper surface of the feeding motor connects to the protection plate.

9. The cooling device for a feeding motor of a pick-up head according to claim 7, wherein the upper surface of the feeding motor is flush with the protection plate.

10. The cooling device for a feeding motor of a pick-up head according to claim 7, wherein the install recess is disposed on the side of the spindle.
